(19) United States
(12) Patent Application Publication
(10) Pub. No.: US 2005/0071950 A1
(43) Pub. Date: Apr. 7, 2005

(54) Biased door retaining assembly

(76) Inventor: Paul Nantais, Tecumseh (CA)

Correspondence Address: MILLER THOMPSON, LLP, 20 QUEEN STREET WEST, SUITE 2500, TORONTO, ON, M5H 3S1, CA

(21) Appl. No.: 10/951,897

(22) Filed: Sep. 29, 2004

Related U.S. Application Data
(60) Provisional application No. 60/507,104, filed on Oct. 1, 2003.

(51) Int. Cl. E05F 5/06

(52) U.S. Cl. 16/85

(57) ABSTRACT

A biased door retaining assembly including a hook member, a support assembly having a biasing means, and an arm having a first end and a second end. The support assembly and the biasing means may engage the first end of the arm biasing the arm in a first direction. The second end of the arm is adapted to engage the hook member.

### FIELD OF THE INVENTION

This invention relates in general to retaining devices such as a door stop and more particularly to a biased door retaining assembly.

### BACKGROUND OF THE INVENTION

There are numerous methods available to secure or retain a door in different positions. These methods of securement vary from placing a variety of objects in front of the door to hold it open, to traditional door stops that are mounted to the door and engage against the floor itself preventing the door from closing but they do not stop the door from hitting the wall.

Prior art door stops have been devised to address some of the below noted problems. For example, U.S. Pat. No. 4,159,837, which issued on Jul. 3, 1979 to Morita relates to the combination of a door stop and releasable latching device, whereby a keeper member is mounted to a conventional door and positioned thereon to engage a stationary door stop having a latching mechanism coupled therewith. The door stop comprises a main supporting body to be mounted in a fixed position relative to the keeper member, the fixed body having a slidable bumper cover which is spring biased in an outwardly direction to engage the head of the keeper, and wherein a latching lever is pivotally mounted to the fixed body and arranged to be actuated by the movement of the slidable bumper cover for releasable latching over the head of the keeper when the door is positioned in an open mode.

U.S. Pat. No. 5,556,141 which issued on Sep. 17, 1996 to Rogers relates to a three-part cabinet latch, a first part of which is relatively rigid, is attached to the cabinet door and has a hook shaped portion on one end. Another part is relatively resilient, is attached to the cabinet floor and has a hook shaped end which cooperates with the hook shaped portion on the first part to hold the door closed. A third part of the cabinet latch is a quick release pin installed through a hole in the cabinet floor, and when pushed up will force the resilient second part to release from the first part so the door can be opened.

U.S. Pat. No. 5,975,593 which issued on Nov. 2, 1999 to Cress relates to a foot operated cabinet latch concealed in the cabinet kick-space of commonly used storage cabinets in, for example, kitchens and bathrooms. The cabinet latch has an operator knob located in the cabinet kick-space and a flexible lever and strike located inside the cabinet. Operation of the latch is accomplished by engaging a person's foot with the knob and pushing in an upwards direction. This action serves to disengage the lever from the strike and the cabinet door can then be opened.

Lefebvre is the owner of U.S. Pat. No. 5,226,201 which issued on Jul. 13, 1993 and relates to an improved door stop which is adapted to retain a door in an open position, the door stop having a base which can be secured to a suitable wall or floor surface, a stopping portion which functions in the manner of a normal door stop, and a retaining member having an abutment formed therein to retain the door between the abutment and the stopping portion, the retaining member being moveable into and out of a door retaining position. The device permits a door to be opened and securely retained in an open position, the structure permits easy replacement of parts which can be sized to fit different doors.

However, prior art devices are often complex in nature and therefore are difficult and time consuming to assemble. Furthermore, in light of the complexity of these devices, they are often bulky in nature and obtrusive to the surrounding decor as well as expensive. Finally the bulky nature and additional parts of these devices often make them difficult to clean and maintain.

Thus, a door retaining assembly which can be mounted to either the wall or floor, that has fewer components, is easy to assemble and install, is cheaper to manufacture, is not conspicuous to the surrounding decor is desirable.

### SUMMARY OF THE INVENTION

An object of one aspect of the present invention is to provide an improved biased door retaining assembly.

In accordance with one aspect of the present invention there is provided a biased door retaining assembly including a hook member, a support assembly having a biasing means, and an arm having a first end and a second end. The support assembly and the biasing means may engage the first end of the arm biasing the arm in a first direction. The second end of the arm is adapted to engage the hook member.

Conveniently, the support assembly may be mounted to either the floor or the wall. Mounting the support assembly does not require precise installation or alignment.

Preferably, the biased door assembly may be moved from a biased first direction to an opposite direction using the user's foot and pushing the arm in an opposite direction.

Advantages of the present invention are: fewer components, cheaper to manufacture, less complex therefore easy to assemble, easy to install and does not require precise measuring or alignment to function, unobtrusive to surrounding decor, easy to clean and maintain.

### BRIEF DESCRIPTION OF THE DRAWINGS

A detailed description of the preferred embodiment is provided herein below by way of example only and with reference to the following drawings, in which:

FIG. 1 is a side view, illustrating a biased door retaining assembly in accordance with the preferred embodiment of the present invention;

FIG. 2 is a front plan view, illustrating the support assembly.

FIG. 3 is a front view of the hook member.

FIG. 4 is a side elevational view of the biased door retaining assembly mounted to the floor.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

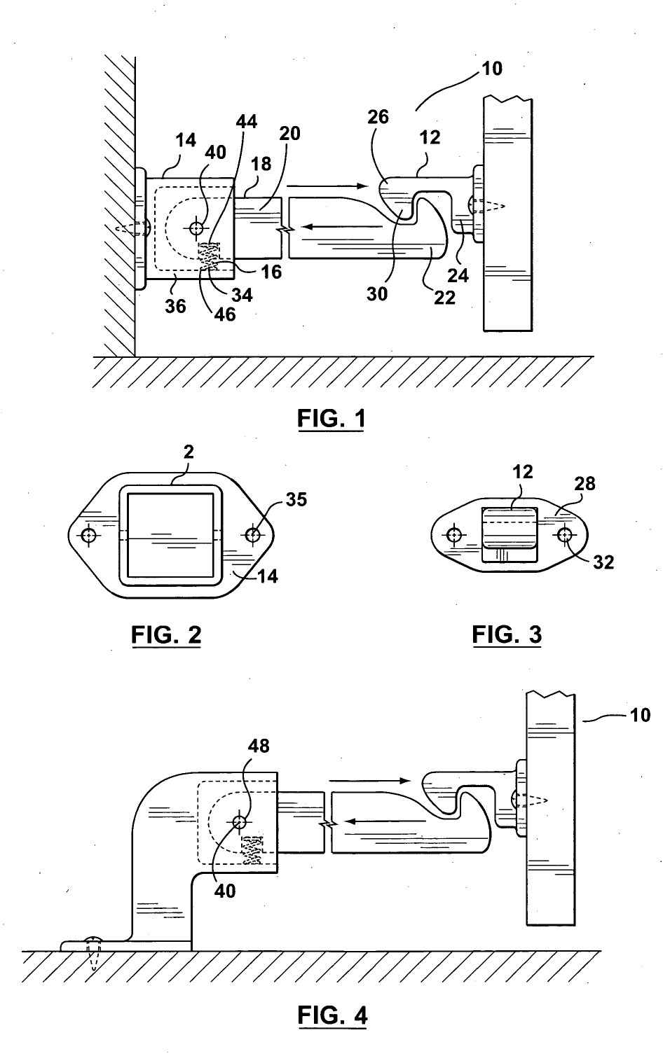

Referring to FIGS. 1 and 4, there is illustrated in a side elevational view, a biased door retaining assembly 10 in accordance with the preferred embodiment of the present invention. The biased door retaining assembly 10 includes a hook member 12, a support assembly 14 having a biasing means 16 and an arm 18 having a first end 20 and a second end 22.

Referring to FIGS. 1 and 3, the hook member 12 may further comprise of a first end 24 and a second end 26. The first end 24 may have a mounting portion 28 and the second end 26 may have a hook portion 30. The mounting portion 28 may be configured a variety of ways so as to allow the hook member 12 to be mounted to different surfaces. For example, the mounting portion 28 may be a straight configuration to mount on a wall or door, or the mounting portion 28 may be curved so as to mount on the floor.

The mounting portion 28 may also include a series of holes 32 that allow the mounting portion 28 to be mounted on these various surfaces using a variety of fasteners such as screws, nails etc. The mounting portion 28 may also be mounted to these surfaces using other means such as adhesives and the like.

Referring to FIG. 2, the support assembly 14 may further comprise of a base portion 36 having a series of holes (not shown) configured to receive a pivot pin 40, as well a series of holes 35 for mounting the support assembly 14 to a surface. The surface may be either moveable or stationary, such as a door or a wall by way of example. Whatever surface the support assembly is mounted to, the mounting portion 28 must be mounted to a different surface. In other words if the support assembly is mounted to a door, the mounting portion 28 must be mounted to a wall or other stationary surface such as a floor to allow the biased door retaining assembly 10 to function.

The base portion 36 may also be adapted to receive the biasing means 16. The biasing means 16 of the support assembly 14 may further comprise of a spring 34 that is adapted to have one end 44 of the spring 34 fit into the first end 20 of the arm 18, and the second end 46 of the spring 34 engage the base portion 36.

The first end 20 of the arm 18 may further comprise a series of holes 48 positioned and configured to receive the. pivot pin 40. Therefore the pivot pin 40 may slide through the series of holes (not shown) in the base portion 36 and the series of holes 48, in the first end 20 of the arm 18 so as to allow the arm 18 to moveably engage the support assembly 14. The positioning of the spring 34 allows for the biasing of the arm 18 in a first direction. Depending on the direction of the mounting of the support assembly 14, the first direction may be either up or down. Traditionally the first direction is upwards.

The second end 22 of the arm 18 is adapted to engage the hook portion 30. More specifically the second end 22 of the arm 18 is hook shaped so as to latch onto or hook the hook portion 30 of the hook member 12. The hook shaped second end 22 must be oriented in the opposite direction of the hook portion 30 to allow the engagement or latching of the hook portion 30 and the hooked shaped second end 22. Traditionally the hook shaped second end 22 is oriented in an upward manner, whereas the hook portion 30 is oriented in a downward manner.

The activation of the biasing door retaining assembly 10 may occur when the hooked shaped second end 22 of the arm 18 engages the hook portion 30. The activation occurs with the movement of the arm 18. The direction of the movement will depend whether the orientation of the hooked shaped second end 22 is in an upward or downward position.

Typically the hook portion 30 and the hooked shaped second end 22 contact one another when the door having the hook portion 30 is moved to engage the hooked shaped second end 22. When contact occurs between the hooked shaped second end 22 and the hook portion 30, the spring 44 engages and the arm 18 automatically moves in a downward fashion. The arm 18 continues to move downward until there is complete engagement of the hook portion 30 with the hooked shaped second end 22, at which point the arm 18 then biases upwards into its first position thereby activating the biasing door retraining assembly 10. This action does not require the user to exert any pressure on the arm 18.

The biasing door retaining assembly 10 may also be activated by the user applying a downward pressure on the arm 18, so as to move the hook shaped second end 22 to a position aligned with the hooked member 30 to allow the engagement of the hooked shaped second end 22 of the arm 18. When the user releases the pressure, the arm 18 will move upward by the biasing means 16 or spring 34 and engage the hook portion 30. Engagement of the hook portion 30 by the hooked shaped second end 22 of the arm 18, allows the biased door retaining assembly 10 to be activated.

To deactivate the biased door retaining assembly 10, the user may apply downward pressure against the arm 18 and therefore the spring 34, thereby forcing the arm 18 in a downward fashion and releasing the hook shaped second end 22 of the arm 18 from engagement with the hook portion 30. This movement is accomplished by the pivot pin 40, which allows the arm 18 to pivot relative to the base portion 36 when pressure is applied to the arm 18 and therefore allows the arm 18 to move in a downward fashion. The application of a downward pressure causes the spring 34 to compress.

Once the hook shaped second end 22 of the arm 18 is disengaged from the hook portion 30, the user may move the door out of range of the arm 18, the user may release the pressure on the arm 18, and the spring 34 will bias the arm 18 in an upward direction.

Other variations and modifications of the invention are possible. All such modifications or variations are believed to be within the sphere and scope of the invention as defined by the claims appended hereto.

1. A biased door retaining assembly comprising:
(a) a hook member having a first end with a mounting portion to mount to a first surface and a second end with a hook portion;
(b) a support assembly having a biasing means, said support assembly adapted to mount to a second surface, and
(c) an arm having a first end and a second end;
wherein said support assembly and said biasing means is adapted to engage said first end of-said arm biasing said arm in a first direction and said second end of said arm is adapted to engage said hook portion of said second end of said hook member wherein said hook portion latches on to said second end of said arm from a second opposite direction without applying pressure on said arm.

2. A door retaining assembly as claimed in claim 1 wherein said second end of said arm further comprises a hook shape adapted to engage said hook portion of said hook member.

3. A door retaining assembly as claimed in claim 2 wherein said hook shape is oriented in, an opposite direction to said hook portion of said hook member.

4. A door retaining assembly as claimed in claim 2 wherein said hook shape is oriented up and said hook portion of said hook member is oriented down.

5. A door retaining assembly as claimed in claim 2 wherein said hook shape is oriented down and said hook portion of said hook member is oriented up.

6. A door retaining assembly as claimed in claim 1 wherein said mounting portion is configured to mount on a door.

7. A door retaining assembly as claimed in claim 1 wherein said mounting portion is configured to mount on a wall.

8. A door retaining assembly as claimed in claim 1 wherein said mounting portion is configured to mount on a floor.

9. A door retaining assembly as claimed in claim 1 wherein said mounting portion is adhered to said first surface by a fastening means.

10. A door retaining assembly as claimed in claim 9 wherein said fastening means are screws, nails or adhesives.

11. A door retaining assembly as claimed in claim 1 wherein said support assembly further comprises a base portion adapted to receive a pivoting means.

12. A door retaining assembly as claimed in claim 11 wherein said pivoting means is a pivot pin that engages a series of apertures in said base portion and in said first end of said arm allowing said arm to moveably engage said support assembly.

13. A door retaining assembly as claimed in claim 11 wherein said base portion further comprises a second series of apertures for mounting said support assembly to said second surface.

14. A door retaining assembly as claimed in claim 1 wherein said second surface is a wall.

15. A door retaining assembly as claimed in claim 1 wherein said second surface is door.

16. A door retaining assembly as claimed in claim 1 wherein said support assembly is mounted to said second surface that is opposite to said first surface that said mounting portion is adhered to.

17. A door retaining assembly as claimed in claim 11 wherein said biasing means further comprises a spring having a first end adapted to fit into said first end of said arm and a second end adapted to engage said base portion.

18. A door retaining assembly as claimed in claim 17 wherein said spring biases said arm in an upward direction.

19. A door retaining assembly as claimed in claim 17 wherein said spring biases said arm in a downward direction.

20. A method of activating a door retaining assembly having a hook member having a first end with a mounting portion to mount to a first surface and a second end with a hook portion, an arm having a first end and a second end adapted to engage said hook portion of said second end of said hook member, and a support assembly having a biasing means adapted to engage said first end of said arm biasing said arm in a first direction, said support assembly adapted to mount to a second surface, comprising:
(a) biasing said arm in a first direction by said biasing means;
(b) moving said second end of said arm to contact said hook portion;
(c) engaging said biasing means whereby said arm automatically moves in a second direction until there is complete engagement of said hook portion with said second end of said arm; and
(d) biasing said arm into said first direction upon engagement of said hook portion by said second end of said arm.
